(19) United States
(12) Patent Application Publication
(10) Pub. No.: US 2007/0147752 A1
(43) Pub. Date: Jun. 28, 2007

(54) Photonic crystal fibers and systems using photonic crystal fibers

(75) Inventors: Ori Weisberg, Misgav Dov (IL); Gregor Dellemann, Ulm (DE); Uri Kolodny, Tel-Aviv (IL); David Torres, Stoughton, MA (US); Charalambos Anastassiou, Malden, MA (US); Steven A. Jacobs, Needham, MA (US); Gil Shapira, Brookline, MA (US); Burak Temelkuran, Boston, MA (US); Aaron Micetich, Natick, MA (US); Rokan Ahmad, Bedford, NH (US); Ytshak Avrahami, Arlington, MA (US); Yelena Kann, Marblehead, MA (US); Max Shurgalin, Lexington, MA (US); Yoel Fink, Brookline, MA (US); Tairan Wang, Waltham, MA (US)

Correspondence Address: FISH & RICHARDSON PC, P.O. BOX 1022, MINNEAPOLIS, MN, 55440-1022, US

(73) Assignee: OMNIGUIDE, INC.

(21) Appl. No.: 11/449,947

(22) Filed: Jun. 9, 2006

Related U.S. Application Data
(60) Provisional application No. 60/689,624, filed on Jun. 10, 2005.

(51) Int. Cl. G02B 6/032

(52) U.S. Cl. 385/123; 385/125

(57) ABSTRACT

In general, in one aspect, the invention features methods that include guiding radiation at a first wavelength, λ₁, through a core of a photonic crystal fiber and guiding radiation at a second wavelength, λ₂, through the photonic crystal fiber, wherein |λ₁−λ₂|>100 nm.

### CROSS-REFERENCE TO RELATED APPLICATIONS

Under 35 U.S.C. § 119(e)(1), this application claims priority to Provisional Patent Application No. 60/689,624, entitled “PHOTONIC CRYSTAL FIBERS AND SYSTEMS USING PHOTONIC CRYSTAL FIBERS,” filed on Jun. 10, 2005, the entire contents of which are hereby incorporated by reference.

### BACKGROUND

This invention relates to the field of photonic crystal waveguides and systems using photonic crystal waveguides.

Waveguides play important roles in numerous industries. For example, optical waveguides are widely used in telecommunications networks, where fiber waveguides such as optical fibers are used to carry information between different locations as optical signals. Such waveguides substantially confine the optical signals to propagation along a preferred path or paths. Other applications of optical waveguides include imaging applications, such as in an endoscope, and in optical detection. Optical waveguides can also be used to guide laser radiation (e.g., high intensity laser radiation) from a source to a target in medical (e.g., eye surgery) and manufacturing (e.g., laser machining and forming) applications.

The most prevalent type of fiber waveguide is an optical fiber, which utilizes index guiding to confine an optical signal to a preferred path. Such fibers include a core region extending along a waveguide axis and a cladding region surrounding the core about the waveguide axis and having a refractive index less than that of the core region. Because of the index-contrast, optical rays propagating substantially along the waveguide axis in the higher-index core can undergo total internal reflection (TIR) from the core-cladding interface. As a result, the optical fiber guides one or more modes of electromagnetic (EM) radiation to propagate in the core along the waveguide axis. The number of such guided modes increases with core diameter. Notably, the index-guiding mechanism precludes the presence of any cladding modes lying below the lowest-frequency guided mode for a given wavevector parallel to the waveguide axis. Almost all index-guided optical fibers in use commercially are silica-based in which one or both of the core and cladding are doped with impurities to produce the index contrast and generate the core-cladding interface. For example, commonly used silica optical fibers have indices of about 1.45 and index contrasts ranging from about 0.2% to 3% for wavelengths in the range of 1.5 μm, depending on the application.

### SUMMARY

Fiber waveguides capable of guiding radiation through different portions of the waveguides are disclosed. For example, in some embodiments, fiber waveguides guide radiation through both the core and the cladding. The different portions can guide radiation at different wavelengths (e.g., at wavelengths in completely different regions of the electromagnetic spectrum). The different portions can guide radiation using different confinement mechanisms. For example, one portion can confine the radiation using a photonic crystal structure, while another portion can confine radiation by total internal reflection.

In general, in a first aspect, the invention features methods that include guiding radiation at a first wavelength, λ₁, through a core of a photonic crystal fiber and guiding radiation at a second wavelength, λ₂, through the photonic crystal fiber, wherein |λ₁−λ₂|>100 nm (e.g., about 200 nm, about 300 nm, about 400 nm, about 500 nm, about 750 nm, about 1,000 nm, about 2,000 nm, about 3,000 nm, about 5,000 nm, about 10,000 nm).

Implementations of the methods can have one or more of the following features and/or features of other aspects. The radiation at the first wavelength can be coupled into the core of the photonic crystal fiber at an end of the photonic crystal fiber. The radiation at the second wavelength can also be coupled into the photonic crystal fiber at an end of the photonic crystal fiber. Alternatively, or additionally, the radiation at the second wavelength can be coupled into the photonic crystal fiber at a side of the photonic crystal fiber.

The photonic crystal fiber can include a confinement region surrounding the core and a cladding surrounding the confinement region, and the radiation at the second wavelength can be guided through the cladding.

The first wavelength can be in a range from about 1,300 nm to about 12,000 nm (e.g., about 1,500 nm or more, about 2,000 nm or more). For example, the first wavelength is about 10,600 nm. The second wavelength can be in a range from about 400 nm to about 700 nm (e.g., about 633 nm).

In general, in another aspect, the invention features methods that include guiding radiation at a first wavelength, λ₁, through a hollow core of a fiber waveguide and guiding radiation at a second wavelength, λ₂, through a portion of the fiber waveguide surrounding the core.

Implementations of the methods can have one or more of the following features and/or features of other aspects. The first and second wavelengths can be different. |λ₁−λ₂| can be greater than 100 nm (e.g., about 200 nm, about 300 nm, about 400 nm, about 500 nm, about 750 nm, about 1,000 nm, about 2,000 nm, about 3,000 nm, about 5,000 nm, about 10,000 nm). λ₁ can be in the infrared region of the electromagnetic spectrum. For example, λ₁ can be about 10,600 nm. λ₂ can be in the visible portion of the electromagnetic spectrum.

The fiber waveguide can include a cladding surrounding the core and the radiation at the second wavelength can be guided through the cladding. For example, the radiation at the second wavelength can be guided by total internal reflection of the radiation at an interface between the cladding and another portion of the fiber waveguide or between the cladding and a gas or fluid. In some embodiments, the interface is between the cladding and air.

The fiber waveguide can be a photonic crystal fiber.

In general, in a further aspect, the invention features systems that include a first radiation source configured to emit radiation at a first wavelength during operation of the first radiation source, a second radiation source configured to emit radiation at a second wavelength during operation of the second radiation source, and a photonic crystal fiber having an output end, the photonic crystal fiber being positioned to receive radiation at the first and second wavelengths from the first and second radiation sources during operation of the first and second radiation sources, respectively, and to guide the radiation at the first and second wavelengths to the output end.

Embodiments of the systems can include one or more of the following features and/or features of other aspects. The first radiation source can be a laser (e.g., a CO₂ laser). Alternatively, or additionally, the second radiation source can be a laser. The first and second wavelengths can be different. The first wavelength can be in a non-visible portion of the electromagnetic spectrum. For example, the first wavelength can be in the infrared portion of the electromagnetic spectrum. The second wavelength can be in the visible portion of the electromagnetic spectrum.

The systems can include a handpiece attached to the photonic crystal fiber, wherein the handpiece allows an operator to control the orientation of the output end to direct the radiation to a target location of a patient. The handpiece can include an endoscope. The endoscope can include a flexible conduit and a portion of the photonic crystal fiber can be threaded through a channel in the flexible conduit. The endoscope can include an actuator mechanically coupled to the flexible conduit configured to bend a portion of the flexible conduit thereby allowing the operator to vary the orientation of the output end. In some embodiments, the handpiece includes a conduit and a portion of the photonic crystal fiber is threaded through the conduit. The conduit can include a bent portion.

The photonic crystal fiber can be sufficiently flexible to guide the radiation at the first and second wavelengths to the target location while a portion of the photonic crystal fiber is bent through an angle of about 90 degrees or more and the portion has a radius of curvature of about 12 centimeters or less. The radiation at the first wavelength can have an average power at the output end of about 5 Watts or more.

The photonic crystal fiber can include a core and a confinement region surrounding the core, the core and confinement region both extending along a waveguide axis. The dielectric confinement region can include a layer of a first dielectric material arranged in a spiral around the waveguide axis. The dielectric confinement region further can further include a layer of a second dielectric material arranged in a spiral around the waveguide axis, the second dielectric material having a different refractive index from the first dielectric material. The first dielectric material can be a glass, such as a chalcogenide glass or an oxide glass. The second dielectric material can be a polymer. The dielectric confinement region can include at least one layer of a chalcogenide glass. The dielectric confinement region can include at least one layer of a polymeric material. The dielectric confinement region can include at least one layer of a first dielectric material extending along the waveguide axis and at least one layer of a second dielectric material extending along the waveguide axis, wherein the first and second dielectric materials can be co-drawn with the first dielectric material. The core can be a hollow core. The photonic crystal fiber can be a Bragg fiber. The photonic crystal fiber can be a holey fiber. The photonic crystal fiber can include a confinement region surrounding a core of the photonic crystal fiber, and the confinement region comprises a spiral portion. The confinement region can also include a non-spiral portion. The non-spiral portion can be located between the spiral portion and the core. The non-spiral portion can be an annular portion.

In general, in a further aspect, the invention features photonic crystal fibers that include a core extending along a waveguide axis, a confinement region surrounding the core, the confinement region also extending along the waveguide axis, a cladding surrounding the confinement region and extending along the waveguide axis, the cladding comprising a cladding material having a refractive index nC at a wavelength λ, and a portion adjacent the cladding, the portion also extending along the waveguide axis, wherein the portion has a refractive index nₚ at λ, where nₚ<n_{c}.

Embodiments of the photonic crystal fibers can include one or more of the following features and/or features of other aspects. For example, the cladding material can be a polymer. The polymer can include a polyolefin. The cladding material can have a relatively low absorption at λ. The portion adjacent the cladding can surround the cladding. The portion surrounding the cladding can include one or more support structures positioned to maintain a separation between the cladding and an outer cladding surrounding the cladding. The portion can include holey portions. The cladding can include a material with a relatively low absorption at λ. The material can be a polymer.

Among other advantages, the methods, systems, and photonic crystal fibers allow one to guide two or more different wavelengths from a source or sources to a target location using a single fiber waveguide. The guided wavelengths can be in completely different regions of the electromagnetic spectrum. For example, one wavelength can be in the infrared portion of the spectrum, while another guided wavelength can be in the visible portion of the spectrum.

The different wavelengths can be used for completely different purposes at the target location. For example, the radiation at one of the wavelengths can be high powered radiation used for cutting or ablating a target. The other wavelength can be used to provide an aiming beam so that can operator can see where the fiber will direct the high power radiation. As an example, waveguides can be used in medical laser systems to guide an invisible beam (e.g., radiation from a CO₂ laser at 10.6 microns) and a visible beam (e.g., radiation from a HeNe laser at 0.633 microns) to a target location on a patient. The visible beam can be used to aim the fiber so that the operator is confident that the invisible radiation will be directed to the desired location.

The details of one or more embodiments of the invention are set forth in the accompanying drawings and the description below. Certain references are incorporated into the specification by reference. In case of conflict, the current specification will control.

Other features, objects, and advantages of the invention will be apparent from the description and drawings, and from the claims.

### DESCRIPTION OF DRAWINGS

FIG. 1 is a schematic diagram of a system that includes a photonic crystal fiber.

FIG. 2A is a cross-section view of an embodiment of a photonic crystal fiber.

FIG. 2B-2D are cross-sectional views of embodiments of confinement regions for photonic crystal fibers.

FIG. 3 is a cross-sectional diagram of another embodiment of a photonic crystal fiber.

FIG. 4 is a cross-sectional diagram of a further embodiment of a photonic crystal fiber.

FIG. 5 is a cross-sectional diagram of another embodiment of a photonic crystal fiber.

FIG. 6 is a cross-sectional diagram of an embodiment of a photonic crystal fiber with another fiber waveguide embedded in the photonic crystal fiber cladding.

FIG. 7 is a schematic diagram of an embodiment of a medical laser system.

FIG. 8 is a schematic diagram of an embodiment of a medical laser system.

Like reference symbols in the various drawings indicate like elements.

### DETAILED DESCRIPTION

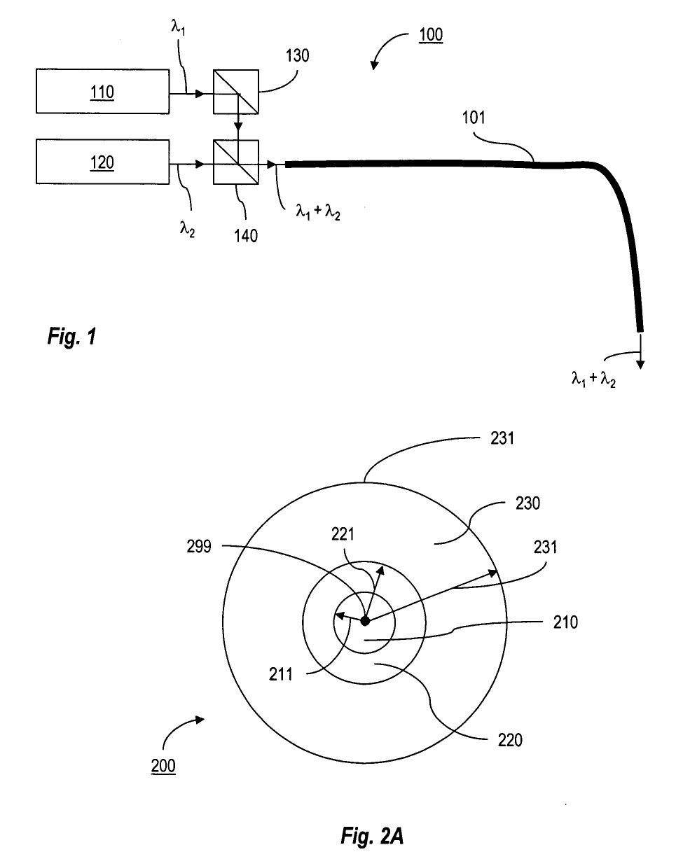

Referring to FIG. 1, a laser system 100 includes a first laser 110 and a second laser 120. The system is configured to deliver radiation from lasers 110 and 120 to a target through a photonic crystal fiber 101.

The first laser emits radiation at a first wavelength, λ₁. System 100 includes a pair of reflectors (e.g., mirrors) 130 and 140 that direct the radiation at λ₁ from laser 110 into a proximal end of photonic crystal fiber 101. λ₁ is in the infrared portion of the electromagnetic spectrum. For example, laser 120 can be a CO₂ laser and λ₁ can be about 10,600 nm. In some embodiments, the infrared radiation emitted by laser 120 has relatively high power. For example, laser 120 can have an average power of about 5 Watts or more (e.g., about 10 Watts or more, about 15 Watts or more, about 20 Watts or more, about 25 Watts or more, about 30 Watts or more, about 40 Watts or more, about 50 Watts or more, about 100 Watts or more).

The second laser emits radiation at a second wavelength, λ₂, that is different from λ₁. The radiation at λ₂ passes through reflector 140 and couples into the proximal end of photonic crystal fiber 101. λ₂ is in the visible portion of the electromagnetic spectrum, for example, between about 400 nm and 700 nm. For example, laser 120 can be a HeNe laser that emits radiation at 633 nm.

In general, the power of the radiation at λ₂ emitted by the second laser can vary. In some embodiments, the power can be relatively low. For example, the average power from the second laser at λ₂ can be about 500 mW or less (e.g., about 300 mW or less, about 200 mW or less, about 100 mW or less, about 50 mW or less). Alternatively, in certain embodiments, the power from the second laser at λ₂ can be more than 500 mW (e.g., about 1 Watt or more).

Photonic crystal fiber 101 guides the radiation at both λ₁ and λ₂ along its length and delivers it to a target located near the fiber's distal end. In certain embodiments, the radiation at λ₁ delivered by photonic crystal fiber 101 to the target has relatively high power. For example, the average power of λ₁ delivered to the target can be about 5 Watts or more (e.g., about 10 Watts or more, about 15 Watts or more, about 20 Watts or more, about 25 Watts or more, about 30 Watts or more, about 40 Watts or more, about 50 Watts or more). In embodiments where the radiation at λ₁ is used to cut or ablate a material (e.g., animal tissue or a metal), the power delivered by photonic crystal fiber 101 at λ₁ should be sufficient to accomplish these tasks.

The radiation at λ₂ delivered by photonic crystal fiber can vary depending on the function of this radiation. For example, in embodiments where the radiation at λ₂ is used as a guide for an operator of laser system 100, the power delivered by photonic crystal fiber at λ₂ should be sufficient to be seen by the operator at the target. In embodiments, the radiation at λ₂ delivered by photonic crystal fiber to the target has an average power in a range from about 1 mW to about 500 mW (e.g., about 10 mW or more, about 50 mW or more, and/or about 250 mW or less, about 100 mW or less).

In some embodiments, system 100 can include additional optical components to couple radiation from the lasers into the end of photonic crystal fiber 101. For example, system 100 can include one or more lenses or other passive optical components to direct (e.g., focus) the radiation towards the end of the fiber. System 100 can include connectors that mechanically attach the end of the fiber to a coupling assembly that maintains the position of the fiber's end to the coupling optical components.

The length of photonic crystal fiber 101 can vary as desired. In some embodiments, the fiber is about 1.2 meters long or more (e.g., about 1.5 meters or more, about 2 meters or more, about 3 meters or more, about 5 meters or more). The length is typically dependent on the specific application for which the laser system is used. In applications where laser 110 can be positioned close to the target, the length of the fiber can be relatively short (e.g., about 1.5 meters or less, about 1.2 meters or less, about 1 meter or less). In certain applications, the length of fiber 120 can be very short (e.g., about 50 centimeters or less, about 20 centimeters or less, about 10 centimeters or less).

While laser system 100 is configured to deliver radiation at infrared and visible wavelengths, in general, laser systems can provide radiation at other wavelengths too. Generally, laser systems can deliver radiation at ultraviolet (UV), visible, and/or infrared (IR) wavelengths. Lasers delivering IR radiation, for example, emit radiation having a wavelength between about 0.7 microns and about 20 microns (e.g., between about 2 to about 5 microns or between about 8 to about 12 microns). Waveguides having hollow cores, such as photonic crystal fiber 101, are well-suited for use with laser systems having wavelengths of about 2 microns or more, since gases that commonly occupy the core have relatively low absorptions at these wavelengths compared to many dielectric materials (e.g., silica-based glasses and various polymers). In addition to CO₂ lasers, other examples of lasers which can emit IR radiation include Nd:YAG lasers (e.g., at 1.064 microns), Er:YAG lasers (e.g., at 2.94 microns), Er, Cr:YSGG (Erbium, Chromium doped Yttrium Scandium Gallium Garnet) lasers (e.g., at 2.796 microns), Ho:YAG lasers (e.g., at 2.1 microns), free electron lasers (e.g., in the 6 to 7 micron range), and quantum cascade lasers (e.g., in the 3 to 5 micron range).

In addition to HeNe lasers, examples of lasers that emit visible radiation include visible diode lasers, Argon Ion lasers (e.g., at 488 nm or 514 nm), and Nd:YAG lasers (e.g., at 532 nm).

More generally, λ₁ and λ₂ can be the same or different. In some embodiments, |λ₁−λ₂| is about 20 nm or more (e.g., about 30 nm or more, about 50 nm or more, about 80 nm or more, about 100 nm or more, about 150 nm or more, about 200 nm or more, about 300 nm or more, about 500 nm or more, about 1,000 nm or more, about 2,000 nm or more, about 3,000 nm or more, about 5,000 nm or more, about 7,500 nm or more, about 10,000 nm or more).

Furthermore, laser systems can deliver radiation at more than two discrete wavelengths. For example, laser systems can deliver radiation at three or more discrete wavelengths or for bands of wavelengths.

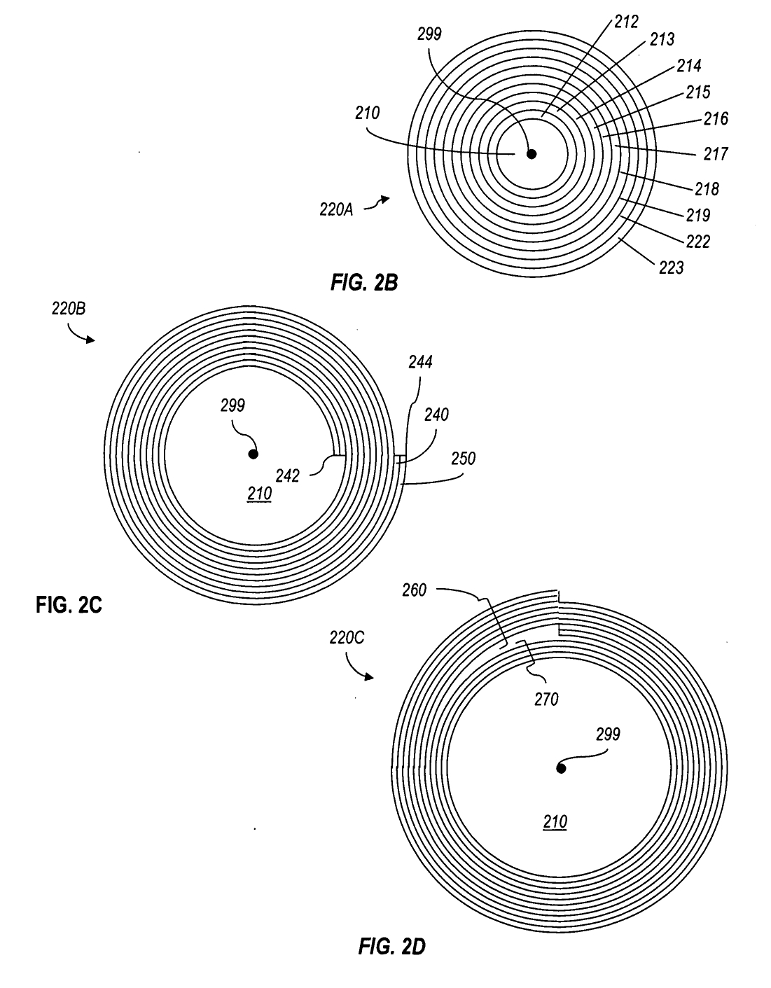

Referring to FIG. 2A, in general, photonic crystal fiber 101 includes a core 210, which is surrounded by a confinement region 220 extending along a waveguide axis 299 (normal to the plane of FIG. 2A). Confinement region 220 is surrounded by a cladding 230 (e.g., a polymer cladding), which provides mechanical support and protects the core and confinement region from environmental hazards. Confinement region 220 includes a photonic crystal structure that substantially confines radiation at a wavelength λ₁ to core 210. Examples of such structures are described with reference to FIGS. 2B-2D below. In some embodiments, photonic crystal fiber 101 guides radiation at λ₂ by substantially confining certain modes within cladding 230. The modes are confined by total internal reflection at the outer surface 231 of cladding 230.

As used herein, a photonic crystal is a structure (e.g., a dielectric structure) with a refractive index modulation (e.g., a periodic refractive index modulation) that produces a photonic bandgap in the photonic crystal. An example of such a structure, giving rise to a one dimensional refractive index modulation, is a stack of dielectric layers of high and low refractive index, where the layers have substantially the same optical thickness. A photonic bandgap, as used herein, is a range of frequencies in which there are no accessible extended (i.e., propagating, non-localized) states in the dielectric structure. Typically the structure is a periodic dielectric structure, but it may also include, e.g., more complex “quasi-crystals.” The bandgap can be used to confine, guide, and/or localize light by combining the photonic crystal with “defect” regions that deviate from the bandgap structure. Moreover, there are accessible extended states for frequencies both below and above the gap, allowing light to be confined even in lower-index regions (in contrast to index-guided TIR structures). The term “accessible” states means those states with which coupling is not already forbidden by some symmetry or conservation law of the system. For example, in two-dimensional systems, polarization is conserved, so only states of a similar polarization need to be excluded from the bandgap. In a waveguide with uniform cross-section (such as a typical fiber), the wavevector β is conserved, so only states with a given β need to be excluded from the bandgap to support photonic crystal guided modes. Moreover, in a waveguide with cylindrical symmetry, the “angular momentum” index m is conserved, so only modes with the same m need to be excluded from the bandgap. In short, for high-symmetry systems the requirements for photonic bandgaps are considerably relaxed compared to “complete” bandgaps in which all states, regardless of symmetry, are excluded.

Theoretically, a photonic crystal is only completely reflective in the bandgap when the index modulation in the photonic crystal has an infinite extent. Otherwise, incident radiation can “tunnel” through the photonic crystal via an evanescent mode that couples propagating modes on either side of the photonic crystal. In practice, however, the rate of such tunneling decreases exponentially with photonic crystal thickness (e.g., the number of alternating layers). It also decreases with the magnitude of the index contrast in the confinement region.

Furthermore, a photonic bandgap may extend over only a relatively small region of propagation vectors. For example, a dielectric stack may be highly reflective for a normally incident ray and yet only partially reflective for an obliquely incident ray. A “complete photonic bandgap” is a bandgap that extends over all possible wavevectors and all polarizations. Generally, a complete photonic bandgap is only associated with a photonic crystal having index modulations along three dimensions. However, in the context of EM radiation incident on a photonic crystal from an adjacent dielectric material, we can also define an “omnidirectional photonic bandgap,” which is a photonic bandgap for all possible wavevectors and polarizations for which the adjacent dielectric material supports propagating EM modes. Equivalently, an omnidirectional photonic bandgap can be defined as a photonic band gap for all EM modes above the light line, wherein the light line defines the lowest frequency propagating mode supported by the material adjacent the photonic crystal. For example, in air the light line is approximately given by ω=cβ, where ω is the angular frequency of the radiation, β is the wavevector, and c is the speed of light. A description of an omnidirectional planar reflector is disclosed in U.S. Pat. No. 6,130,780, the entire contents of which are incorporated herein by reference. Furthermore, the use of alternating dielectric layers to provide omnidirectional reflection (in a planar limit) for a cylindrical waveguide geometry is disclosed in Published PCT application WO 00/22466, the contents of which are incorporated herein by reference.

When confinement region 220 gives rise to an omnidirectional bandgap with respect to core 210, the guided modes are strongly confined because, in principle, any EM radiation incident on the confinement region from the core is completely reflected. As described above, however, such complete reflection only occurs when there are an infinite number of layers. For a finite number of layers (e.g., about 20 layers), an omnidirectional photonic bandgap may correspond to a reflectivity in a planar geometry of at least 95% for all angles of incidence ranging from 0° to 80° and for all polarizations of EM radiation having frequency in the omnidirectional bandgap. Furthermore, even when fiber 101 has a confinement region with a bandgap that is not omnidirectional, it may still support a strongly guided mode, e.g., a mode with radiation losses of less than 0.1 dB/km for a range of frequencies in the bandgap. Generally, whether or not the bandgap is omnidirectional will depend on the size of the bandgap produced by the alternating layer (which generally scales with index contrast of the two layers) and the lowest-index constituent of the photonic crystal.

Regarding the structure of photonic crystal fiber 101, in general, the radius of core 210 (indicated by reference numeral 211 in FIG. 2A) can vary depending on the end-use application of system 100. For example, where a large spot size is desired, the core can be relatively large (e.g., have a radius of about 0.5 mm or more, about 1 mm or more). Alternatively, when a small spot size is desired, core radius 211 can be much smaller (e.g., about 250 microns or less, about 150 microns or less, about 100 microns or less, about 50 microns or less).

More generally, where fiber 101 is used in systems with other types of laser, and/or used to guide wavelengths other than 10.6 microns, the core radius depends on the wavelength or wavelength range of the energy to be guided by the fiber, and on whether the fiber is a single or multimode fiber. For example, where the fiber is a single mode fiber for guiding visible wavelengths (e.g., between about 400 nm and about 700 nm) the core radius can be in the sub-micron to several micron range (e.g., from about 0.5 microns to about 5 microns). However, the core radius can be in the tens to thousands of microns range (e.g., from about 10 microns to about 2,000 microns, such as about 500 microns to about 1,000 microns), for example, where the fiber is a multimode fiber for guiding IR wavelengths. The core radius can be about 5λ or more (e.g., about 10λ or more, about 20λ or more, about 50λ or more, about 100λ or more), where λ is the wavelength of the guided energy.

An advantage of photonic crystal fibers is that fibers having small core radii can be readily produced since fibers can be drawn from a perform, preserving the relative proportions of the fiber's cross-sectional structure while reducing the dimensions of that structure to small sizes in a controlled manner.

In photonic crystal fiber 101, core 210 is hollow. Alternatively, in embodiments where there are no fluids pumped through the core, core 210 can include any material or combination of materials that are rheologically compatible with the materials forming confinement region 210 and that have sufficiently high transmission properties at the guided wavelength(s). In some embodiments, core 210 includes a dielectric material (e.g., an amorphous dielectric material), such as an inorganic glass or a polymer. In certain embodiments, core 210 can include one or more dopant materials, such as those described in U.S. patent application Ser. No. 10/121,452, entitled “HIGH INDEX-CONTRAST FIBER WAVEGUIDES AND APPLICATIONS,” filed Apr. 12, 2002 and now published under Pub. No. US-2003-0044158-A1, the entire contents of which are hereby incorporated by reference.

In general, the refractive index of core 211 at λ₁ can vary depending on its composition. For example, where core 211 is hollow, the core's refractive index, n_{core}, is about 1. Alternatively, where core 211 is not hollow, n_{core} can be about 1.3 or more (e.g., about 1.4 or more, about 1.5 or more, about 1.6 or more, about 1.7 or more, about 1.8 or more, about 2 or more).

As discussed previously, cladding 230 guides radiation at λ₂ by total internal reflection of radiation at the outer surface of the cladding. Guided modes can include modes that intersect the confinement region and core. Alternatively, or additionally, guided modes can include helical modes, that do not intersect the confinement region.

Typically, cladding 230 should be formed from a material that has relatively low absorption at λ₂. Low absorption materials are defined below. Generally, the refractive index of cladding 230 at λ₂, n_{clad}, can vary depending on the cladding's composition. In some embodiments, n_{clad} is about 1.4 or more (e.g., about 1.5 or more, about 1.6 or more, about 1.7 or more, about 1.8 or more, about 2 or more).

The material used to form cladding 230 can be selected so that photonic crystal fiber has relatively low loss at λ₂. For example, in some embodiments, fiber 101 can have losses of about 10 dB/m for radiation at 2 (e.g., about 5 dB/m or less, about 3 dB/m or less, about 2 dB/m or less, about 1 dB/m or less, about 0.5 dB/m or less).

Cladding 230 can be formed from one or more polymers (e.g., an acrylate, olefin, or silicone polymer) and/or other materials. Examples of polymers that can be used are listed below in regard to the structure of the confinement region. Polyolefins, as an example, can have relatively low absorption for visible wavelengths, compared to PES, for example. Accordingly, polyolefins can be used where λ₂ is in the visible portion of the electromagnetic spectrum.

Cladding 230 can be formed from a material that is also used to as part of confinement region 220, which are described below. In applications where the cladding comes in contact with a patient, such as in medical laser systems, it can be formed from materials that conform to FDA standards for medical devices. In these instances, silicone polymers, for example, may be particularly suited for use as the cladding material.

In some embodiments, in addition to providing a waveguide for radiation at λ₂, cladding 230 protects the fiber from external damage. By selecting the appropriate thickness, composition, and/or structure, cladding 230 can also be designed to limit the flexibility of the fiber, e.g., to prevent damage by small radius of curvature bends.

Cladding 230 has a radius indicated by reference numeral 231. In general, radius 231 can vary. In some embodiments, radius 231 is about twice or more (e.g., about three times or more, about four times or more, about five times or more, about six times or more, about eight times or more, about 10 times or more, about 12 times or more, about 15 times or more, about 20 times or more) as large than radius 211.

The outer diameter (OD) of fiber 101 is twice radius 231. The OD can be selected so that fiber 101 is compatible with other pieces of equipment. For example, fiber 101 can be made so that the OD is sufficiently small so that the fiber can be threaded through a channel in an endoscope or other tool (e.g., the OD can be about 2,000 microns or less). In some embodiments, fiber 101 has a relatively small OD (e.g., about 1,000 microns or less). Narrow fibers can be useful in applications where they are to be inserted into narrow spaces, such as through a patient's urethra. Alternatively, in some embodiments, the OD of fiber 101 can be relatively large (e.g., about 3,000 microns or more). Large OD's can reduce the mechanical flexibility of the fiber, which can prevent the fiber from bending to small radii of curvature that damage the fiber or reduce its transmission to a level where the system can no longer perform its intended function.

Where radiation at λ₂ is guided through cladding 230, the OD can also be selected based on the guiding properties of fiber 101 at λ₂. For example, the OD can be selected to provide lower losses of radiation at λ₂. An OD that provides reduce loss at λ₂ can be determined by considering theoretical models of the fiber and/or empirically.

Turning to the structure and composition of confinement region 220, confinement region 220 has a radius indicated by reference numeral 221 that can vary depending on the structure of the confinement region (e.g., the number of periodic units in the confinement region and the wavelength for which the confinement region is designed) and the radius of core 210. In some embodiments, radius 221 is about 1.1 or more (e.g., about 1.2 or more, about 1.3 or more, about 1.4 or more, about 1.5 or more, the 1.6 or more, the 1.8 or more, about two or more, about 2.2 or more, about 2.5 or more, about three or more, about four or more, about five or more) times radius 211.

In some embodiments, photonic crystal fiber 101 is a Bragg fiber and confinement region 220 includes multiple alternating layers having high and low refractive indexes (at λ₁), where the high and low index layers have similar optical thickness. High and low refractive indexes are relative. The high index can be about 1.5 or more (e.g., about 1.6 or more, about 1.7 or more, about 1.8 or more, about 1.9 or more, about 2 or more, about 2.1 or more, about 2.2 or more, about 2.3 or more, about 2.4 or more, about 2.5 or more, about 2.8 or more). The low refractive index is less than the high refractive index. The low refractive index can be less than 2.8 (e.g., less than 2.7, less than 2.6, less, than 2.5, less than 2.4, less than 2.3, less than 2.2, less than 2.1, less than 2, less than 1.9, less than 1.8, less than 1.7, less than 1.6, less than 1.5)

Referring to FIG. 2B, in some embodiments, confinement region 220A includes multiple annular dielectric layers of differing refractive index (i.e., layers composed of a high index material having a refractive index n_{H}, and layers composed of a low index material having a refractive index n_{L}), indicated as layers 212, 213, 214, 215, 216, 217, 218, 219, 222, and 223. Here, n_{H}>n_{L} and n_{H}−n_{L} can be, for example, about 0.01 or more, about 0.05 or more, about 0.1 or more, about 0.2 or more, about 0.5 or more. For convenience, only a few of the dielectric confinement layers are shown in FIG. 2B. In practice, confinement region 220A may include many more layers (e.g., about 15 layers or more, about 20 layers or more, about 30 layers or more, about 40 layers or more, about 50 layers or more, about 80 layers or more).

In some embodiments, confinement region 220 can give rise to an omnidirectional bandgap with respect to core 210, wherein the guided modes are strongly confined because, in principle, any EM radiation at λ₁ incident on the confinement region from the core is completely reflected. However, such complete reflection only occurs when there are an infinite number of layers. For a finite number of layers (e.g., about 20 layers), an omnidirectional photonic bandgap may correspond to a reflectivity in a planar geometry of at least 95% for all angles of incidence ranging from 0° to 80° and for all polarizations of EM radiation having frequency in the omnidirectional bandgap. Furthermore, even when fiber 101 has a confinement region with a bandgap that is not omnidirectional, it may still support a strongly guided mode, e.g., a mode with radiation losses of less than 0.1 dB/km for a range of frequencies in the bandgap. Generally, whether or not the bandgap is omnidirectional will depend on the size of the bandgap produced by the alternating layers (which generally scales with index contrast of the two layers) and the lowest-index constituent of the photonic crystal.

The existence of an omnidirectional bandgap, however, may not be necessary for useful application of fiber 101. For example, in some embodiments, a laser beam used to establish the propagating field in the fiber is a TEM₀₀ mode. This mode can couple with high efficiency to the HE₁₁ mode of a suitably designed fiber. Thus, for successful application of the fiber for transmission of laser energy, it may only be necessary that the loss of this one mode be sufficiently low. More generally, it may be sufficient that the fiber support only a number of low loss modes (e.g., the HE₁₁ mode and the modes that couple to it from simple perturbations, such as bending of the fiber). In other words, photonic bandgap fibers may be designed to minimize the losses of one or a group of modes in the fiber, without necessarily possessing an omnidirectional bandgap.

For a planar dielectric reflector, it is well-known that, for normal incidence, a maximum band gap is obtained for a “quarter-wave” stack in which each layer has equal optical thickness λ/4, or equivalently

$${n}_{hi} {d}_{hi} = {n}_{lo} {d}_{lo} = λ / 4 ,$$

where d_{hi/lo} and n_{hi/lo} refer to the thickness and refractive index, respectively, of high-index and low-index layers in the stack. Normal incidence, however, corresponds to β=0, whereas for a cylindrical waveguide the desired modes typically lie near the light line ω=cβ (in the limit of large R, the lowest-order modes are essentially plane waves propagating along z-axis, i.e., the waveguide axis). In this case, the quarter-wave condition becomes:

$${d}_{hi} \sqrt{{n}_{hi}^{2} - 1} = {d}_{lo} \sqrt{{n}_{lo}^{2} - 1} = λ / 4 \qquad ( 1 )$$

This equation may not be exactly optimal because the quarter-wave condition is modified by the cylindrical geometry, which may require the optical thickness of each layer to vary smoothly with its radial coordinate. In addition, the differing absorption of the high and low index materials can change the optimal layer thicknesses from their quarter-wave values.

In certain embodiments, confinement region 220 includes layers that do not satisfy the quarter-wave condition given in Eq. 1. In other words, for the example shown in FIG. 2B, one or more of layers 212, 213, 214, 215, 216, 217, 218, 219, 222, and 223 are thicker or thinner than d_{λ/4}, where

$${d}_{λ / 4} = \frac{λ}{4 \sqrt{{n}^{2} - 1}} ,$$

and n is the refractive index of the layer (i.e., d_{λ/4} corresponds to an optical thickness equal to the quarter-wave thickness). For example, one or more layers in the confinement region can have a thickness of about 0.9 d_{λ/4} or less (e.g., about 0.8 d_{λ/4} or less, about 0.7 d_{λ/4} or less, about 0.6 d_{λ/4} or less, about 0.5 d_{λ/4} or less, about 0.4 d_{λ/4} or less, about 0.3 d_{λ/4} or less), or about 1.1 d_{λ/4} or more (e.g., about 1.2 d_{λ/4} or more, about 1.3 d_{λ/4} or more, about 1.4 d_{λ/4} or more, about 1.5 d_{λ/4} or more, about 1.8 d_{λ/4} or more, about 2.0 d_{λ/4} or more).

In some embodiments, all layers in the confinement region can be detuned from the quarter-wave condition. In some embodiments, the thickness of one or more of the high index layers can be different (e.g., thicker or thinner) from the thickness of the other high index layers. For example, the thickness of the innermost high index layer can be different from the thickness of the other high index layers. Alternatively, or additionally, the thickness of one or more of the low index layers can be different (e.g., thicker or thinner) from the thickness of the other low index layers. For example, the thickness of the innermost low index layer can be different from the thickness of the other low index layers.

Detuning the thickness of layers in the confinement region from the quarter-wave condition can reduce the attenuation of photonic crystal fiber 101 compared to a test fiber, which refers to a fiber identical to photonic crystal fiber 101, except that the quarter-wave condition is satisfied for all layers in the confinement region (i.e., the test fiber has an identical core, and its confinement region has the same number of layers with the same composition as photonic crystal fiber 101). For example, fiber 101 can have an attenuation for one or more guided modes that is reduced by a factor of about two or more compared to the attenuation of the test fiber (e.g., reduced by a factor of about three or more, about four or more, about five or more, about ten or more, about 20 or more, about 50 or more, about 100 or more). Examples of photonic crystal fibers illustrating reduce attenuation are described in U.S. patent application Ser. No. 10/978,605, entitled “PHOTONIC CRYSTAL WAVEGUIDES AND SYSTEMS USING SUCH WAVEGUIDES,” filed on Nov. 1, 2004, the entire contents of which is hereby incorporated by reference.

The thickness of each layer in the confinement region can vary depending on the composition and structure of the photonic crystal fiber. Thickness can also vary depending on the wavelength, mode, or group of modes for which the photonic crystal fiber is optimized. The thickness of each layer can be determined using theoretical and/or empirical methods. Theoretical methods include computational modeling. One computational approach is to determine the attenuation of a fiber for different layer thicknesses and use an optimization routine (e.g., a non-linear optimization routine) to determine the values of layer thickness that minimize the fiber's attenuation for a guided mode. For example, the “downhill simplex method”, described in the text Numerical Recipes in FORTRAN (second edition), by W. Press, S. Teukolsky, W. Vetterling, and B Flannery, can be used to perform the optimization.

Such a model should account for different attenuation mechanisms in a fiber. Two mechanisms by which energy can be lost from a guided EM mode are by absorption loss and radiation loss. Absorption loss refers to loss due to material absorption. Radiation loss refers to energy that leaks from the fiber due to imperfect confinement. Both modes of loss contribute to fiber attenuation and can be studied theoretically, for example, using transfer matrix methods and perturbation theory. A discussion of transfer matrix methods can be found in an article by P. Yeh et al., J. Opt. Soc. Am., 68, p. 1196 (1978). A discussion of perturbation theory can found in an article by M. Skorobogatiy et al., Optics Express, 10, p. 1227 (2002). Particularly, the transfer matrix code finds propagation constants β for the “leaky” modes resonant in a photonic crystal fiber structure. Imaginary parts of β's define the modal radiation loss, thus Loss_{radiation}˜Im(β). Loss due to material absorption is calculated using perturbation theory expansions, and in terms of the modal field overlap integral it can be determined from

$${Loss}_{absorption} \sim 2 πω {\int }_{0}^{∞} r ⅆ r ( α {\vec{E}}_{β}^{*} {\vec{E}}_{β} ) , \qquad ( 2 )$$

where ω is the radiation frequency, r is the fiber radius, α is bulk absorption of the material, and \vec{E}_{β} is an electric field vector.

Alternatively, the desired mode fields that can propagate in the fiber can be expanded in a suitable set of functions, such as B-splines (see, e.g., A Practical Guide to Splines, by C. deBoor). Application of the Galerkin conditions (see, e.g., Computational Galerkin Methods, C. A. J. Fletcher, Springer-Verlag, 1984) then converts Maxwell's equations into a standard eigenvalue-eigenvector problem, which can be solved using the LAPACK software package (freely available, for example, from the netlib repository on the internet, at “http://www.netlib.org”). The desired complex propagation constants, containing both material and radiation losses, are obtained directly from the eigenvalues.

Guided modes can be classified as one of three types: pure transverse electric (TE); pure transverse magnetic (TM); and mixed modes. Loss often depends on the type of mode. For example, TE modes can exhibit lower radiation and absorption losses than TM/mixed modes. Accordingly, the fiber can be optimized for guiding a mode that experiences low radiation and/or absorption loss.

While confinement region 220A includes multiple annular layers that give rise to a radial refractive index modulation, in general, confinement regions can also include other structures to provide confinement properties. For example, referring to FIG. 2C, a confinement region 220B includes continuous layers 240 and 250 of dielectric material (e.g., polymer, glass) having different refractive indices, as opposed to multiple discrete, concentric layers. Continuous layers 240 and 250 form a spiral around axis 299. One or more of the layers, e.g., layer 240 is a high-index layer having an index n_{H} and a thickness d_{H}, and the layer, e.g., layer 250, is a low-index layer having an index n_{L} and a thickness d_{L}, where n_{H}>n_{L} (e.g., n_{H}−n_{L} can be about 0.01 or more, about 0.05 or more, about 0.1 or more, about 0.2 or more, about 0.5 or more).

Because layers 240 and 250 spiral around axis 199, a radial section extending from axis 199 intersects each of the layers more than once, providing a radial profile that includes alternating high index and low index layers.

The spiraled layers in confinement region 220B provide a periodic variation in the index of refraction along a radial section, with a period corresponding to the optical thickness of layers 240 and 250. In general, the radial periodic variation has an optical period corresponding to n₂₄₀d₂₄₀+n₂₅₀d₂₅₀.

The thickness (d₂₄₀ and d₂₅₀) and optical thickness (n₂₄₀d₂₄₀ and n₂₅₀d₂₅₀) of layers 240 and 250 are selected based on the same considerations as discussed for confinement region 220A above.

For the embodiment shown in FIG. 2C, confinement region 220B is 5 optical periods thick. In practice, however, spiral confinement regions may include many more optical periods (e.g., about 8 optical periods or more, about 10 optical periods or more, about 15 optical periods or more, about 20 optical periods or more, about 25 optical periods or more, such as about 40 or more optical periods).

The end of the spiraled layers form a pair of seams 242 and 244, one adjacent core 210 and one adjacent the cladding.

Fiber's having spiral confinement regions can be formed from a spiral perform by rolling a planar multilayer film into a spiral and consolidating the spiral by fusing (e.g., by heating) the adjacent layers of the spiral together. In some embodiments, the planar multilayer film can be rolled into a spiral around a mandrel (e.g., a glass cylinder or rod), and the mandrel can be removed (e.g., by etching or by separating the mandrel from the spiral sheath and slipping it out of the sheath) after consolidation to provide the spiral cylinder. The mandrel can be formed from a single material, or can include portions of different materials. For example, in some embodiments, the mandrel can be coated with one or more layers that are not removed after consolidation of the rolled spiral structure. As an example, a mandrel can be formed from a first material (e.g., a silicate glass) in the form of a hollow rod, and a second material (e.g., another glass, such as a chalcogenide glass) coated onto the outside of the hollow rod. The second material can be the same as one of the materials used to form the multilayer film. After consolidation, the first material is etched, and the second material forms part of the fiber preform.

In some embodiments, additional material can be disposed on the outside of the wrapped multilayer film. For example, a polymer film can be wrapped around the outside of the spiral, and subsequently fused to the spiral to provide an annular polymer layer (e.g., the cladding). In certain embodiments, both the multilayer film and an additional film can be wrapped around the mandrel and consolidated in a single fusing step. In embodiments, the multilayer film can be wrapped and consolidated around the mandrel, and then the additional film can be wrapped around the fused spiral and consolidated in a second fusing step. The second consolidation can occur prior to or after etching the mandrel. Optionally, one or more additional layers can be deposited (e.g., using CVD) within the spiral prior to wrapping with the additional film.

Methods for preparing spiral articles are described in U.S. patent application Ser. No. 10/733,873, entitled “FIBER WAVEGUIDES AND METHODS OF MAKING SAME,” filed on Dec. 10, 2003, the entire contents of which are hereby incorporated by reference.

Referring to FIG. 2D, in some embodiments, photonic crystal fiber 101 can include a confinement region 220C that includes a spiral portion 260 and an annular portion 270. The number of layers in annular portion 270 and spiral portion 260 (along a radial direction from the fiber axis) can vary as desired. In some embodiments, annular portion can include a single layer. Alternatively, as shown in FIG. 2D, annular portion 270 can include multiple layers (e.g., two or more layers, three or more layers, four or more layers, five or more layers, ten or more layers).

In embodiments where annular portion 270 includes more than one layer, the optical thickness of each layer may be the same or different as other layers in the annular portion. In some embodiments, one or more of the layers in annular portion 270 may have an optical thickness corresponding to the quarter wave thickness (i.e., as given by Eq. (1). Alternatively, or additionally, one or more layers of annular portion 270 can have a thickness different from the quarter wave thickness. Layer thickness can be optimized to reduce (e.g., minimize) attenuation of guided radiation using the optimization methods disclosed herein.

In certain embodiments, annular portion 270 can be formed from materials that have relatively low concentrations of defects that would scatter and/or absorb radiation guided by photonic crystal fiber 101. For example, annular portion 270 can include one or more glasses with relatively low concentrations of inhomogeneities and/or impurities. Inhomogeneities and impurities can be identified using optical or electron microscopy, for example. Raman spectroscopy, glow discharge mass spectroscopy, sputtered neutrals mass spectroscopy or Fourier Transform Infrared spectroscopy (FTIR) can also be used to monitor inhomogeneities and/or impurities in photonic crystal fibers.

In certain embodiments, annular portion 270 is formed from materials with a lower concentration of defects than spiral portion 260. In general, these defects include both structural defects (e.g., delamination between layers, cracks) and material inhomogeneities (e.g., variations in chemical composition and/or crystalline structure).

Fibers having confinement regions such as shown in FIG. 2D can be prepared by depositing one or more annular layers onto a surface of a cylinder having a spiral cross-section to form a preform. The photonic crystal fiber can then be drawn from the preform.

Annular layers can be deposited onto a surface of the spiral cylinder using a variety of deposition methods. For example, where the spiral portion is between the annular portion and the core, material can be evaporated or sputtered onto the outer surface of the spiral article to form the preform.

In embodiments where the annular portion of the photonic crystal fiber is between the spiral portion and the core, material can be deposited on the inner surface of the spiral article by, for example, chemical vapor deposition (e.g., plasma enhanced chemical vapor deposition). Methods for depositing layers of, for example, one or more glasses onto an inner surface of a cylindrical preform are described in U.S. patent application Ser. No. 10/720,453, entitled “DIELECTRIC WAVEGUIDE AND METHOD OF MAKING THE SAME,” filed on Nov. 24, 2003, the entire contents of which are hereby incorporated by reference.

In general, a confinement region may include photonic crystal structures different from a multilayer configuration. For example, confinement region 220C includes both a spiral portion and annular portion, in some embodiments, confinement regions can include portions with other non-spiral structure. For example, a confinement region can include a spiral portion and a holey portion (e.g., composed of a solid cylinder perforated by a number of holes that extend along the fiber's axis). The holes can be arranged along concentric circles, providing a variation in the radial refractive index of the holey portion of the confinement region.

With regard to the composition of confinement region 220, the composition of high index and low index layers are typically selected to provide a desired refractive index contrast between the layers at the fiber's operational wavelength(s). The composition of each high index layer can be the same or different as other high index layers, just as the composition of each low index layer can be the same or different as other low index layers.

Suitable materials for high and low index layers can include inorganic materials such as inorganic glasses or amorphous alloys. Examples of inorganic glasses include oxide glasses (e.g., heavy metal oxide glasses), halide glasses and/or chalcogenide glasses, and organic materials, such as polymers. Examples of polymers include acrylonitrile-butadiene-styrene (ABS), poly methylmethacrylate (PMMA), cellulose acetate butyrate (CAB), polycarbonates (PC), polystyrenes (PS) (including, e.g., copolymers styrene-butadiene (SBC), methylestyrene-acrylonitrile, styrene-xylylene, styrene-ethylene, styrene-propylene, styrene-acylonitrile (SAN)), polyetherimide (PEI), polyvinyl acetate (PVAC), polyvinyl alcohol (PVA), polyvinyl chloride (PVC), polyoxymethylene; polyformaldehyde (polyacetal) (POM), ethylene vinyl acetate copolymer (EVAC), polyamide (PA), polyethylene terephthalate (PETP), fluoropolymers (including, e.g., polytetrafluoroethylene (PTFE), polyperfluoroalkoxythylene (PFA), fluorinated ethylene propylene (FEP)), polybutylene terephthalate (PBTP), low density polyethylene (PE), polypropylene (PP), poly methyl pentenes (PMP) (and other polyolefins, including cyclic polyolefins), polytetrafluoroethylene (PTFE), polysulfides (including, e.g., polyphenylene sulfide (PPS)), and polysulfones (including, e.g., polysulfone (PSU), polyehtersulfone (PES), polyphenylsulphone (PPSU), polyarylalkylsulfone, and polysulfonates). Polymers can be homopolymers or copolymers (e.g., (Co)poly(acrylamide-acrylonitrile) and/or acrylonitrile styrene copolymers). Polymers can include polymer blends, such as blends of polyamides-polyolefins, polyamides-polycarbonates, and/or PES-polyolefins, for example.

Further examples of polymers that can be used include cyclic olefin polymers (COPs) and cyclic olefin copolymers (COCs). In some embodiments, COPs and COCs can be prepared by polymerizing norbornen monomers or copolymerization norbornen monomers and other polyolefins (polyethylene, polypropylene). Commercially-available COPs and/or COCs can be used, including, for example, Zeonex® polymers (e.g., Zeonex® E48R) and Zeonor® copolymers (e.g., Zeonor® 1600), both available from Zeon Chemicals L.P. (Louisville, Ky.). COCs can also be obtained from Promerus LLC (Brecksville, Ohio) (e.g., such as FS1700).

Alternatively, or additionally, low-index regions may be fabricated by using hollow structural support materials, such as silica spheres or hollow fibers, to separate high-index layers or regions. Examples of fibers that include such structural supports are described in Published International Application WO 03/058308, entitled “BIREFRINGENT OPTICAL FIBRES,” the entire contents of which are hereby incorporated by reference.

In certain embodiments, the confinement region is a dielectric confinement region, being composed of substantially all dielectric materials, such as one or more glasses and/or one or more dielectric polymers. Generally, a dielectric confinement region includes substantially no metal layers.

In some embodiments, the high index layers or low index layers of the confinement region can include chalcogenide glasses (e.g., glasses containing a chalcogen element, such as sulphur, selenium, and/or tellurium). In addition to a chalcogen element, chalcogenide glasses may include one or more of the following elements: boron, aluminum, silicon, phosphorus, sulfur, gallium, germanium, arsenic, indium, tin, antimony, thallium, lead, bismuth, cadmium, lanthanum and the halides (fluorine, chlorine, bromide, iodine).

Chalcogenide glasses can be binary or ternary glasses, e.g., As—S, As—Se, Ge—S, Ge—Se, As—Te, Sb—Se, As—S—Se, S—Se—Te, As—Se—Te, As—S—Te, Ge—S—Te, Ge—Se—Te, Ge—S—Se, As—Ge—Se, As—Ge—Te, As—Se—Pb, As—S—Tl, As—Se—Tl, As—Te—Tl, As—Se—Ga, Ga—La—S, Ge—Sb—Se or complex, multi-component glasses based on these elements such as As—Ga—Ge—S, Pb—Ga—Ge—S, etc. The ratio of each element in a chalcogenide glass can be varied.

In certain embodiments, in addition or alternative to chalcogenide glass(es), one or more layers in confinement region 220 can include one or more oxide glasses (e.g., heavy metal oxide glasses), halide glasses, amorphous alloys, or combinations thereof.

In general, the absorption of the high and low index layers varies depending on their composition and on the fiber's operational wavelength(s). In some embodiments, the material forming both the high and low index layers can have low absorption. A low absorption material has absorption of about 100 dB/m or less at the wavelength of operation (e.g., about 20 dB/m or less, about 10 dB/m or less, about 5 dB/m or less, about 1 dB/m or less, 0.1 dB/m or less). Examples of low absorption materials include chalcogenide glasses, which, at wavelengths of about 3 microns, exhibit an absorption coefficient of about 4 dB/m. At wavelengths of about 10.6 microns, chalcogenide glasses exhibit an absorption coefficient of about 10 dB/m. As another example, oxide glasses (e.g., lead borosilicate glasses, or silica) can have low absorption for wavelengths between about 1 and 2 microns. Some oxide glasses can have an absorption coefficient of about 1 dB/m to 0.0002 dB/m in this wavelength range.

Alternatively, one or both of the high and low index materials can have high absorption (e.g., about 100 dB/m or more, such as about 1,000 or more, about 10,000 or more, about 20,000 or more, about 50,000 dB/m or more). For example, many polymers exhibit an absorption coefficient of about 10⁵ dB/m for wavelengths between about 3 and about 11 microns. Examples of such polymers include polyetherimide (PEI), polychlorotrifluoro ethylene (PCTFE), perfluoroalkoxyethylene (PFA), and polyethylene naphthalate (PEN). PEI has an absorption of more than about 10⁵ dB/m at 3 microns, while PCTFE, PFA, and PEN have absorptions of more than about 10⁵ dB/m at 10.6 microns.

In some embodiments, the high index material has a low absorption coefficient and the low absorption material has a high absorption coefficient, or vice versa.

A material's absorption can be determined by measuring the relative transmission through at least two different thicknesses, T₁ and T₂, of the material. Assuming the field in the material decays with thickness T according to Pe^{-αT}, with P representing the power incident on the material, the measured transmitted power through thicknesses T₁ and T₂ will then be P₁=Pe^{-αT}^{₁} and P₂=Pe^{-αT}^{₂}. The absorption coefficient α is then obtained as

$$α = - \frac{1}{{T}_{2} - {T}_{1}} ln ( {P}_{2} / {P}_{1} ) .$$

If desired, a more accurate evaluation of α can be obtained by using several thicknesses and performing a least squares fit to the logarithm of the transmitted power.

As discussed previously, materials can be selected for the confinement region to provide advantageous optical properties (e.g., low absorption with appropriate indices of refraction at the guided wavelength(s)). However, the materials should also be compatible with the processes used to manufacture the fiber. In some embodiments, the high and low index materials should preferably be compatible for co-drawing. Criteria for co-drawing compatibility are provided in aforementioned U.S. patent application Ser. No. 10/121,452, entitled “HIGH INDEX-CONTRAST FIBER WAVEGUIDES AND APPLICATIONS.” In addition, the high and low index materials should preferably be sufficiently stable with respect to crystallization, phase separation, chemical attack and unwanted reactions for the conditions (e.g., environmental conditions such as temperature, humidity, and ambient gas environment) under which the fiber is formed, deployed, and used.

When making a robust fiber waveguides using a drawing process, not every combination of materials with desired optical properties is necessarily suitable. Typically, one should select materials that are rheologically, thermo-mechanically, and physico-chemically compatible. Several criteria for selecting compatible materials will now be discussed.

A first criterion is to select materials that are rheologically compatible. In other words, one should select materials that have similar viscosities over a broad temperature range, corresponding to the temperatures experience during the different stages of fiber drawing and operation. Viscosity is the resistance of a fluid to flow under an applied shear stress. Here, viscosities are quoted in units of Poise. Before elaborating on rheological compatibility, it is useful define a set of characteristic temperatures for a given material, which are temperatures at which the given material has a specific viscosity.

The annealing point, T_{α}, is the temperature at which a material has a viscosity 10¹³ Poise. T_{α} can be measured using a Model SP-2A System from Orton Ceramic Foundation (Westerville, Ohio). Typically, T_{α} is the temperature at which the viscosity of a piece of glass is low enough to allow for relief of residual stresses.

The softening point, Tₛ, is the temperature at which a material has a viscosity 10^{7.65} Poise. Tₛ can be measured using a softening point instrument, e.g., Model SP-3A from Orton Ceramic Foundation (Westerville, Ohio). The softening point is related to the temperature at which the materials flow changes from plastic to viscous in nature.

The working point, T_{w}, is the temperature at which a material has a viscosity 10⁴ Poise. T_{w} can be measured using a glass viscometer, e.g., Model SP-4A from Orton Ceramic Foundation (Westerville, Ohio). The working point is related to the temperature at which a glass can be easily drawn into a fiber. In some embodiments, for example, where the material is an inorganic glass, the material's working point temperature can be greater than 250° C., such as about 300° C., 400° C., 500° C. or more.

The melting point, Tₘ, is the temperature at which a material has a viscosity 10² Poise. Tₘ can also be measured using a glass viscometer, e.g., Model SP-4A from Orton Ceramic Foundation (Westerville, Ohio). The melting point is related to the temperature at which a glass becomes a liquid and control of the fiber drawing process with respect to geometrical maintenance of the fiber becomes very difficult.

To be rheologically compatible, two materials should have similar viscosities over a broad temperature range, e.g., from the temperature at which the fiber is drawn down to the temperature at which the fiber can no longer release stress at a discernible rates (e.g., at T_{α}) or lower. Accordingly, the working temperature of two compatible materials should be similar, so that the two materials flow at similar rates when drawn. For example, if one measures the viscosity of the first material, η₁(T) at the working temperature of the second material, T_{w2}, η₁(T_{w2}) should be at least 10³ Poise, e.g., 10⁴ Poise or 10⁵ Poise, and no more than 10⁷ Poise. Moreover, as the drawn fiber cools the behavior of both materials should change from viscous to elastic at similar temperatures. In other words, the softening temperature of the two materials should be similar. For example, at the softening temperature of the second material, Tₛ₂, the viscosity of the first material, η₁(Tₛ₂) should be at least 10⁶ Poise, e.g., 10⁷ Poise or 10⁸ Poise and no more than 10⁹ Poise. In preferred embodiments, it should be possible to anneal both materials together, so at the annealing temperature of the second material, T_{α2}, the viscosity of the first material, η₁(T_{α2}) should be at least 10⁸ Poise (e.g., at least 10⁹ Poise, at least 10¹⁰ Poise, at least 10¹¹ Poise, at least 10¹² Poise, at least 10¹³ Poise, at least 10¹⁴ Poise).

Additionally, to be rheologically compatible, the change in viscosity as a function of temperature (i.e., the viscosity slope) for both materials should preferably match as close as possible.

A second selection criterion is that the thermal expansion coefficients (TEC) of each material should be similar at temperatures between the annealing temperatures and room temperature. In other words, as the fiber cools and its rheology changes from liquid-like to solid-like, both materials' volume should change by similar amounts. If the two materials TEC's are not sufficiently matched, a large differential volume change between two fiber portions can result in a large amount of residual stress buildup, which can cause one or more portions to crack and/or delaminate. Residual stress may also cause delayed fracture even at stresses well below the material's fracture stress.

The TEC is a measure of the fractional change in sample length with a change in temperature. This parameter can be calculated for a given material from the slope of a temperature-length (or equivalently, temperature-volume) curve. The temperature-length curve of a material can be measured using e.g., a dilatometer, such as a Model 1200D dilatometer from Orton Ceramic Foundation (Westerville, Ohio). The TEC can be measured either over a chosen temperature range or as the instantaneous change at a given temperature. This quantity has the units ° C.⁻¹.

For many materials, there are two linear regions in the temperature-length curve that have different slopes. There is a transition region where the curve changes from the first to the second linear region. This region is associated with a glass transition, where the behavior of a glass sample transitions from that normally associated with a solid material to that normally associated with a viscous fluid. This is a continuous transition and is characterized by a gradual change in the slope of the temperature-volume curve as opposed to a discontinuous change in slope. A glass transition temperature, T_{g}, can be defined as the temperature at which the extrapolated glass solid and viscous fluid lines intersect. The glass transition temperature is a temperature associated with a change in the materials rheology from a brittle solid to a solid that can flow. Physically, the glass transition temperature is related to the thermal energy required to excite various molecular translational and rotational modes in the material. The glass transition temperature is often taken as the approximate annealing point, where the viscosity is 10¹³ Poise, but in fact, the measured T_{g} is a relative value and is dependent upon the measurement technique.

A dilatometer can also be used to measure a dilatometric softening point, T_{ds}. A dilatometer works by exerting a small compressive load on a sample and heating the sample. When the sample temperature becomes sufficiently high, the material starts to soften and the compressive load causes a deflection in the sample, when is observed as a decrease in volume or length. This relative value is called the dilatometric softening point and usually occurs when the materials viscosity is between 10¹⁰ and 10^{12.5} Poise. The exact T_{ds} value for a material is usually dependent upon the instrument and measurement parameters. When similar instruments and measurement parameters are used, this temperature provides a useful measure of different materials rheological compatibility in this viscosity regime.

As mentioned above, matching the TEC is an important consideration for obtaining fiber that is free from excessive residual stress, which can develop in the fiber during the draw process. Typically, when the TEC's of the two materials are not sufficiently matched, residual stress arises as elastic stress. The elastic stress component stems from the difference in volume contraction between different materials in the fiber as it cools from the glass transition temperature to room temperature (e.g., 25° C.). The volume change is determined by the TEC and the change in temperature. For embodiments in which the materials in the fiber become fused or bonded at any interface during the draw process, a difference in their respective TEC's will result in stress at the interface. One material will be in tension (positive stress) and the other in compression (negative stress), so that the total stress is zero. Moderate compressive stresses themselves are not usually a major concern for glass fibers, but tensile stresses are undesirable and may lead to failure over time. Hence, it is desirable to minimize the difference in TEC's of component materials to minimize elastic stress generation in a fiber during drawing. For example, in a composite fiber formed from two different materials, the absolute difference between the TEC's of each glass between T_{g} and room temperature measured with a dilatometer with a heating rate of 3° C./min, should be no more than about 5×10⁻⁶° C.⁻¹ (e.g., no more than about 4×10⁻⁶° C.⁻¹, no more than about 3×10⁻⁶° C.⁻¹, no more than about 2×10⁻⁶° C.⁻¹, no more than about 1×10⁻⁶° C.⁻¹, no more than about 5×10⁻⁷° C.⁻¹, no more than about 4×10⁻⁷° C.¹, no more than about 3×10⁻⁷° C.⁻¹, no more than about 2×10⁻⁷° C.⁻¹).

While selecting materials having similar TEC's can minimize an elastic stress component, residual stress can also develop from viscoelastic stress components. A viscoelastic stress component arises when there is sufficient difference between strain point or glass transition temperatures of the component materials. As a material cools below T_{g} it undergoes a sizeable volume contraction. As the viscosity changes in this transition upon cooling, the time needed to relax stress increases from zero (instantaneous) to minutes. For example, consider a composite preform made of a glass and a polymer having different glass transition ranges (and different T_{g}'s). During initial drawing, the glass and polymer behave as viscous fluids and stresses due to drawing strain are relaxed instantly. After leaving the hottest part of the draw furnace, the fiber rapidly loses heat, causing the viscosities of the fiber materials to increase exponentially, along with the stress relaxation time. Upon cooling to its T_{g}, the glass and polymer cannot practically release any more stress since the stress relaxation time has become very large compared with the draw rate. So, assuming the component materials possess different T_{g} values, the first material to cool to its T_{g} can no longer reduce stress, while the second material is still above its T_{g} and can release stress developed between the materials. Once the second material cools to its T_{g}, stresses that arise between the materials can no longer be effectively relaxed. Moreover, at this point the volume contraction of the second glass is much greater than the volume contraction of the first material (which is now below its T_{g} and behaving as a brittle solid). Such a situation can result sufficient stress buildup between the glass and polymer so that one or both of the portions mechanically fail. This leads us to a third selection criterion for choosing fiber materials: it is desirable to minimize the difference in T_{g}'s of component materials to minimize viscoelastic stress generation in a fiber during drawing. Preferably, the glass transition temperature of a first material, T_{g1}, should be within 100° C. of the glass transition temperature of a second material, T_{g2} (e.g., |T_{g1}−T_{g2}| should be less than 90° C., less than 80° C., less than 70° C., less than 60° C., less than 50° C., less than 40° C., less than 30° C., less than 20° C., less than 10° C.).

Since there are two mechanisms (i.e., elastic and viscoelastic) to develop permanent stress in drawn fibers due to differences between constituent materials, these mechanisms may be employed to offset one another. For example, materials constituting a fiber may naturally offset the stress caused by thermal expansion mismatch if mismatch in the materials T_{g}'s results in stress of the opposite sign. Conversely, a greater difference in T_{g} between materials is acceptable if the materials' thermal expansion will reduce the overall permanent stress. One way to assess the combined effect of thermal expansion and glass transition temperature difference is to compare each component materials' temperature-length curve. After finding T_{g} for each material using the foregoing slope-tangent method, one of the curves is displaced along the ordinate axis such that the curves coincide at the lower T_{g} temperature value. The difference in y-axis intercepts at room temperature yields the strain, ε, expected if the glasses were not conjoined. The expected tensile stress, σ, for the material showing the greater amount of contraction over the temperature range from T_{g} to room temperature, can be computed simply from the following equation:
σ=E·ε, (3)
where E is the elastic modulus for that material. Typically, residual stress values less than about 100 MPa (e.g., about 50 MPa or less, about 30 MPa or less), are sufficiently small to indicate that two materials are compatible.

A fourth selection criterion is to match the thermal stability of candidate materials. A measure of the thermal stability is given by the temperature interval (Tₓ−T_{g}), where Tₓ is the temperature at the onset of the crystallization as a material cools slowly enough that each molecule can find its lowest energy state. Accordingly, a crystalline phase is a more energetically favorable state for a material than a glassy phase. However, a material's glassy phase typically has performance and/or manufacturing advantages over the crystalline phase when it comes to fiber waveguide applications. The closer the crystallization temperature is to the glass transition temperature, the more likely the material is to crystallize during drawing, which can be detrimental to the fiber (e.g., by introducing optical inhomogeneities into the fiber, which can increase transmission losses). Usually a thermal stability interval, (Tₓ−T_{g}) of at least about 80° C. (e.g., at least about 100° C.) is sufficient to permit fiberization of a material by drawing fiber from a preform. In preferred embodiments, the thermal stability interval is at least about 120° C., such as about 150° C. or more, such as about 200° C. or more. Tₓ can be measured using a thermal analysis instrument, such as a differential thermal analyzer (DTA) or a differential scanning calorimeter (DSC).

A further consideration when selecting materials that can be co-drawn are the materials' melting temperatures, Tₘ. At the melting temperature, the viscosity of the material becomes too low to successfully maintain precise geometries during the fiber draw process. Accordingly, in preferred embodiments the melting temperature of one material is higher than the working temperature of a second, rheologically compatible material. In other words, when heating a preform, the preform reaches a temperature at it can be successfully drawn before either material in the preform melts.

One example of a pair of materials which can be co-drawn and which provide a photonic crystal fiber waveguide with high index contrast between layers of the confinement region are As₂Se₃ and the polymer PES. As₂Se₃ has a glass transition temperature (T_{g}) of about 180° C. and a thermal expansion coefficient (TEC) of about 24×10⁻⁶/° C. At 10.6 μm, As₂Se₃ has a refractive index of 2.7775, as measured by Hartouni and coworkers and described in Proc. SPIE, 505, 11 (1984), and an absorption coefficient, α, of 5.8 dB/m, as measured by Voigt and Linke and described in “Physics and Applications of Non-Crystalline Semiconductors in Optoelectronics,” Ed. A. Andriesh and M. Bertolotti, NATO ASI Series, 3. High Technology, Vol. 36, p. 155 (1996). Both of these references are hereby incorporated by reference in their entirety. PES has a TEC of about 55×10⁻⁶/° C. and has a refractive index of about 1.65.

Embodiments of photonic crystal fibers and methods for forming photonic crystal fibers are described in the following patents and patent applications: U.S. Pat. No. 6,625,364, entitled “LOW-LOSS PHOTONIC CRYSTAL WAVEGUIDE HAVING LARGE CORE RADIUS;” U.S. Pat. No. 6,563,981, entitled “ELECTROMAGNETIC MODE CONVERSION IN PHOTONIC CRYSTAL MULTIMODE WAVEGUIDES;” U.S. patent application Ser. No. 10/057,440, entitled “PHOTONIC CRYSTAL OPTICAL WAVEGUIDES HAVING TAILORED DISPERSION PROFILES,” and filed on Jan. 25, 2002; U.S. patent application Ser. No. 10/121,452, entitled “HIGH INDEX-CONTRAST FIBER WAVEGUIDES AND APPLICATIONS,” and filed on Apr. 12, 2002; U.S. Pat. No. 6,463,200, entitled “OMNIDIRECTIONAL MULTILAYER DEVICE FOR ENHANCED OPTICAL WAVEGUIDING;” Provisional 60/428,382, entitled “HIGH POWER WAVEGUIDE,” and filed on Nov. 22, 2002; U.S. patent application Ser. No. 10/196,403, entitled “METHOD OF FORMING REFLECTING DIELECTRIC MIRRORS,” and filed on Jul. 16, 2002; U.S. patent application Ser. No. 10/720,606, entitled “DIELECTRIC WAVEGUIDE AND METHOD OF MAKING THE SAME,” and filed on Nov. 24, 2003; U.S. patent application Ser. No. 10/733,873, entitled “FIBER WAVEGUIDES AND METHODS OF MAKING SAME,” and filed on Dec. 10, 2003. The contents of each of the above mentioned patents and patent applications are hereby incorporated by reference in their entirety.

While certain embodiments of photonic crystal fibers have been described, other structures are also possible. For example, in certain embodiments, photonic crystal fiber 101 can include an additional portion adjacent cladding 230 that has a lower refractive index than the cladding thereby facilitating total-internal reflection of the radiation guided by the cladding.

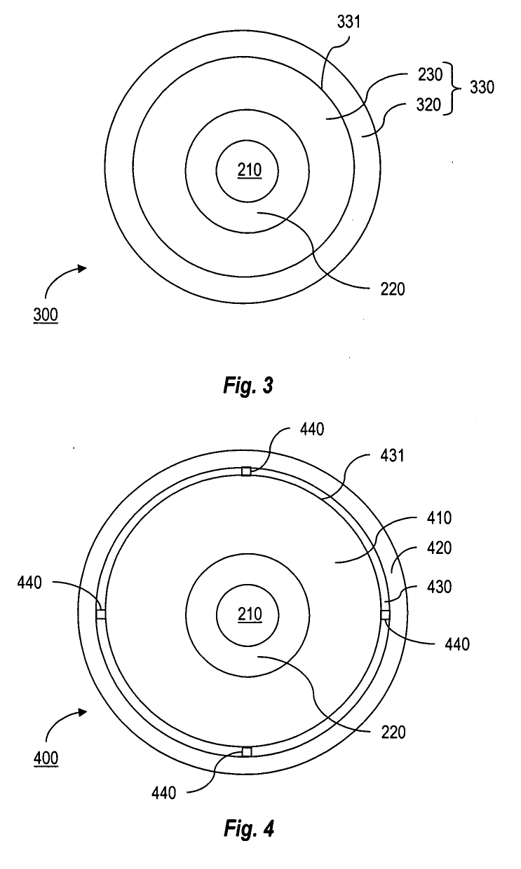

For example, referring to FIG. 3, in some embodiments a fiber 300 includes a compound cladding 330 that includes cladding 230 and a portion 320 surrounding the cladding. Cladding 230 and portion 320 contact each other at an interface 331. Portion 320 has a lower refractive index at λ₂ than does cladding 230. Accordingly, certain radiation at λ₂ within cladding 230 incident on interface 331 experiences total internal reflection, thereby causing photonic crystal fiber 300 to guide radiation at λ₂ within cladding 230.

In some embodiments, portion 320 is formed from a material that can be co-drawn with cladding 230 (e.g., a polymer or inorganic glass). Thus, photonic crystal fiber 300 can be formed from drawing the fiber from a preform having a corresponding structure. Alternatively, fiber 300 can be formed by inserting a drawn structure that includes confinement region 220 and cladding 230 within a sleeve that is subsequently collapsed onto the outer surface of cladding 230. The collapse can be performed by evacuating the space between the surface of cladding 230 and the sleeve at an elevated temperature.

As another example, referring to FIG. 4, in some embodiments a photonic crystal fiber 400 can include an outer cladding 420 that is separated from cladding 230 by a space 430. A number of structural spacers 440 maintain the separation between the outer surface 431 of cladding 230 and outer cladding 420.

The separation between outer cladding 420 and cladding 230 should be sufficiently large to ensure that there is minimal loss of radiation guided by cladding 230 by coupling to outer cladding 420. In some embodiments, the separation is about 5 microns or more (e.g., about 10 microns or more, about 20 microns or more, about 50 microns or more).

The spaces 430 formed by the separation of outer cladding 420 from cladding 230 generally have a lower refractive index at λ₂ than the refractive index of cladding 230. This results in total internal reflection of radiation at λ₂ propagating within cladding 230 at outer surface 431. In some embodiments, spaces 430 are filled with air or some other gas. Alternatively, spaces 430 can be filled with a liquid or solid material.

The composition of cladding 230 can be the same or different than the composition of outer cladding 420. In some embodiments, outer cladding 420 is composed of a material that is substantially opaque at λ₂.

Outer cladding 420 can be of comparable radial thickness to cladding 230, or can be different. In some embodiments, outer cladding 420 is substantially thicker than cladding 230 (e.g., has a thickness of about 0.5 mm or more, about 1 mm or more, about 2 mm or more).

Outer cladding 420 can be a sheath that provides the photonic crystal fiber with protection (e.g., mechanical and/or chemical protection) from external elements. Outer cladding 420 can be formed from a material that is sterilizable (e.g., autoclavable).

In embodiments where the photonic crystal fiber is drawn from a preform, outer cladding 420 can be co-drawn or with the rest of the fiber. Alternatively, the drawn structure can be inserted within outer cladding 420 after being drawn.

The composition of cladding 230 can be the same or different than the composition of structural spacers 440. The spacers can be formed as part of a preform for the photonic crystal fiber, or can be attached to the cladding after drawing. The spacers can extend along the entire portion of the photonic crystal fiber, or can extend distances less than the fiber's entire length. In some embodiments, the spacers are spacer particles that do not extend along the waveguide axis of the fiber.

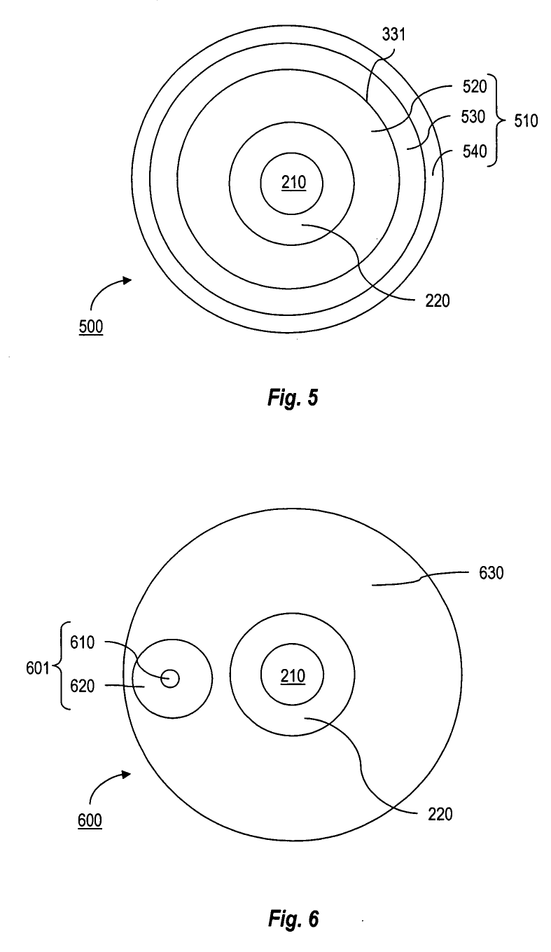

Referring to FIG. 5, a further embodiment of a photonic crystal fiber 500 includes a cladding 510 that has a relatively high-index portion 530 between two relatively lower index portions 520 and 540. Photonic crystal fiber 500 guides light within high-index portion 530 by total internal reflection at the interface between portions 520 and 530 and at the interface between portions 530 and 540.

Referring to FIG. 6, in certain embodiments, a photonic crystal fiber 600 includes a secondary fiber waveguide 601 embedded within cladding 630. Secondary fiber waveguide 601 includes a core 610 and another portion 620 surrounding core 610. Photonic crystal fiber guides light through core 610 in addition to core 210.

Secondary fiber waveguide 601 can be another photonic crystal fiber, in which case portion 620 is another confinement region. Alternatively, secondary fiber waveguide 601 can be a non-photonic crystal fiber, such as a conventional optical fiber (e.g., a single mode or multimode optical fiber). In some embodiments, secondary waveguide 601 includes only core 610 and photonic crystal fiber 600 confines light within core 610 by total internal reflection at the interface between core 610 and cladding 630.

Photonic crystal fiber 600 can be formed in a variety of ways. In some embodiments, a hole is bored in the cladding of a preform for the photonic crystal fiber and a secondary optical waveguide preform is inserted into the hole. Subsequently, the secondary fiber waveguide is co-drawn from the resulting composite preform with the rest of photonic crystal fiber 600. Alternatively, secondary fiber waveguide 601 can be inserted into a hole in cladding 630 after the waveguides have been drawn.

In system 100, radiation from both laser 110 and 120 are coupled into the proximal end of fiber 101. In some embodiments, however, other coupling configurations can be used. For example, radiation from laser 120 can be coupled into the side of fiber 101.

In embodiments where radiation at λ₂ is coupled into the side of fiber 101, cladding 230 should be exposed. In some embodiments, a portion of the cladding surface can be flattened (e.g., cut or machined away) to provide a planar surface that can facilitate coupling of radiation into the cladding.

While the radiation sources in system 100 are lasers, in certain embodiments one or both of the radiation sources can be replaced by non-laser radiation sources. For example, laser 120 can be replaced by a bulb (e.g., a fluorescent bulb) to provide visible light to the photonic crystal fiber.

Moreover, one or both of the radiation sources can be used to provide radiation at more than one wavelength to the fiber. For example, laser 120 can be replaced by a broadband light source that is used to provide a band of wavelengths (e.g., including λ₂) to the fiber. Alternatively, or additionally, laser 110 can be a laser that emits radiation at more than one wavelength (e.g., λ₁ and λ₃, where λ₃ is different from λ₁).

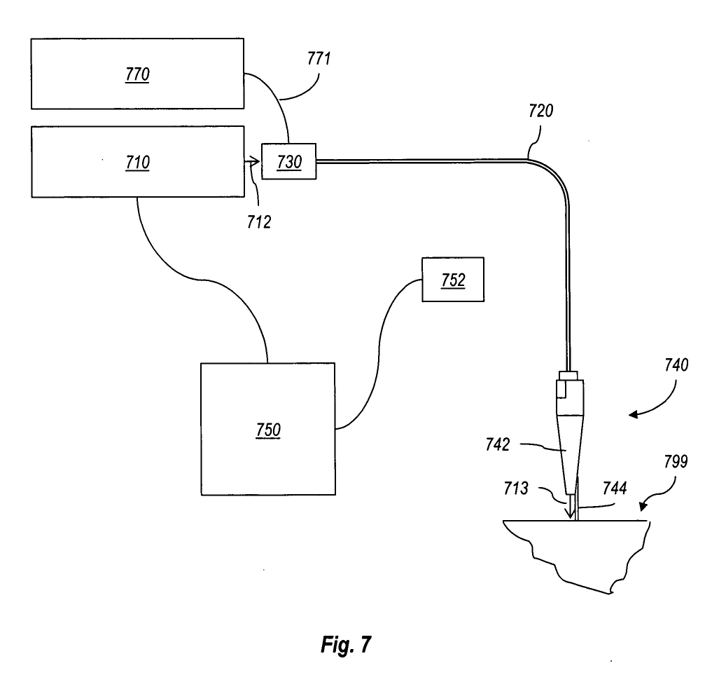

In some embodiments, laser system 100 is a medical laser system. For example, referring to FIG. 7, a medical laser system 700 includes a laser assembly 710, and a photonic crystal fiber 720 having a hollow core to guide radiation 712 from the laser to a target location 799 of a patient. Laser assembly 710 includes a source of radiation at λ₁ and a source of radiation at λ₂. Laser assembly also includes a beam combining assembly to provide radiation 712 to photonic crystal fiber 720. An operator can use radiation at λ₁ to aim (e.g., visible radiation), while the radiation at λ₂ provides the therapeutic or other function (non-visible radiation). Alternatively, or additionally, an operator can deliver multiple different wavelengths to a patient where the different wavelengths have therapeutic uses (e.g., one wavelength to ablate tissue and one wavelength to incise tissue).

Laser radiation 712 is coupled by a coupling assembly 730 into the hollow core of photonic crystal fiber 720, which delivers the radiation through a handpiece 740 to target location 799. During use, an operator (e.g., a medical practitioner, such as a surgeon, a dentist, an ophthalmologist, or a veterinarian) grips a portion 742 of handpiece 740, and manipulates the handpiece to direct laser radiation 713 emitted from an output end of photonic crystal fiber 720 to target location 799 in order to perform a therapeutic function at the target location. For example, the radiation can be used to excise, incise, ablate, or vaporize tissue at the target location.

Laser assembly 710 is controlled by an electronic controller 750 for setting and displaying operating parameters of the system. The operator controls delivery of the laser radiation using a remote control 752, such as a foot pedal. In some embodiments, the remote control includes a component of handpiece 740, allowing the operator to control the direction of emitted laser radiation and delivery of the laser radiation with one hand or both hands. In certain embodiments, the system allows the operator to control the radiation at λ₂ with a control on handpiece 740, and to control the radiation at λ₁ using another control (e.g., a foot pedal).

In addition to grip portion 742, handpiece 740 includes a stand off tip 744, which maintains a desired distance (e.g., from about 0.1 millimeters to about 30 millimeters) between the output end of fiber 720 and target tissue 799. The stand off tip assist the operator in positioning the output end of photonic crystal fiber 720 from target location 799, and can also reduce clogging of the output end due to debris at the target location. In some embodiments, handpiece 740 includes optical components (e.g., a lens or lenses), which focus the beam emitted from the fiber to a desired spot size. The waist of the focused beam can be located at or near the distal end of the stand off tip.

In some embodiments, fiber 720 can be easily installed and removed from coupling assembly 730, and from handpiece 740 (e.g., using conventional fiber optic connectors). This can facilitate ease of use of the system in single-use applications, where the fiber is replaced after each procedure.

Laser system 700 also includes a cooling apparatus 770, which delivers a cooling fluid (e.g., a gas or a liquid) to fiber 720 via a delivery tube 771 and coupling assembly 730. The cooling fluid is pumped through the core and absorbs heat from the fiber surface adjacent the core. In the present embodiment, the cooling fluid flows in the same direction as the radiation from laser assembly 710, however, in some embodiments, the cooling fluid can be pumped counter to the direction of propagation of the laser radiation.

While laser system 700 includes handpiece 740, in general, systems can include different types of handpieces depending on the medical application for which they are being used. In general, a handpiece includes a portion that the operator can grip, e.g., in his/her palm or fingertips, and can include other components as well. In certain embodiments, handpieces can include endoscopes (e.g., flexible or rigid endoscopes), such as a cystoscopes (for investigating a patient's bladder), nephroscopes (for investigating a patient's kidney), bronchoscopes (for investigating a patient's bronchi), laryngoscopes (for investigating a patient's larynx), otoscopes (for investigating a patient's ear), arthroscopes (for investigating a patient's joint), laparoscopes (for investigating a patient's abdomen), and gastrointestinal endoscopes. Another example of a handpiece is a catheter, which allows an operator to position the output end of the photonic crystal fiber into canals, vessels, passageways, and/or body cavities.

Moreover, handpieces can be used in conjunction with other components, without the other component being integrated into the handpiece. For example, handpieces can be used in conjunction with a trocar to position the output end of a photonic crystal fiber within an abdominal cavity of a patient. In another example, a handpiece can be used in conjunction with a rigid endoscope, where the rigid endoscope is not attached to the gripping portion of the handpiece or to the photonic crystal fiber.

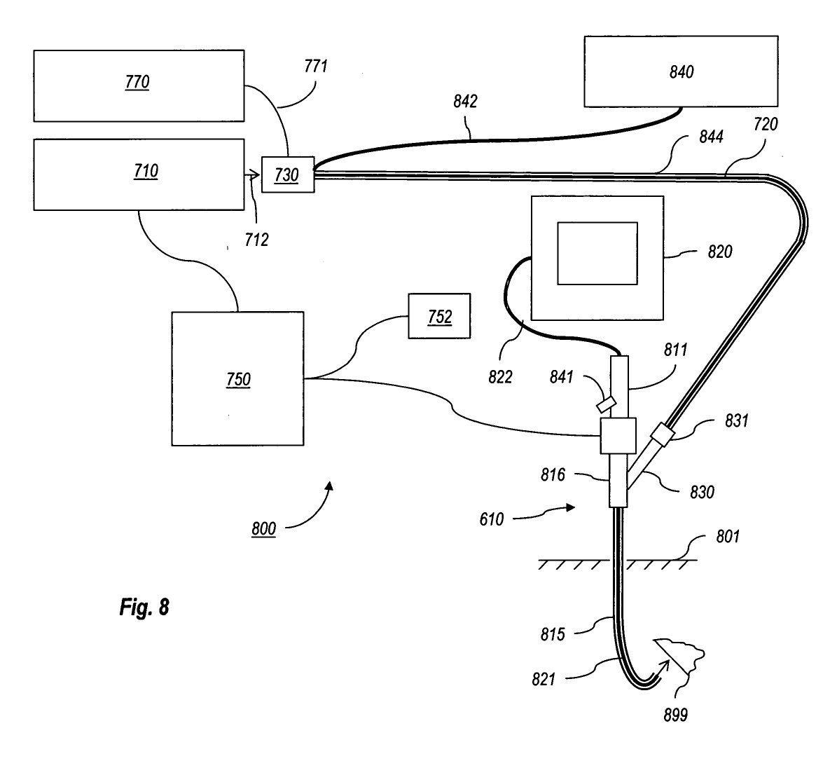

In certain embodiments, handpieces can include actuators that allow the operator to bend the fiber remotely, e.g., during operation of the system. For example, referring to FIG. 8, in some embodiments, laser radiation 712 can be delivered to target tissue 899 within a patient 801 using an endoscope 810. Endoscope 810 includes a gripping portion 811 and a flexible conduit 815 connected to each other by an endoscope body 816. An imaging cable 822 housing a bundle of optical fibers is threaded through a channel in gripping portion 811 and flexible conduit 815. Imaging cable 822 provide illumination to target tissue 899 via flexible conduit 815. The imaging cable also guides light reflected from the target tissue to a controller 820, where it is imaged and displayed providing visual information to the operator. Alternatively, or additionally, the endoscope can include an eyepiece lens that allows the operator to view the target area directly through the imaging cable.

Endoscope 810 also includes an actuator 841 that allows the operator to bend or straighten flexible conduit 815. In some embodiments, actuator 841 allows flexible conduit 815 to bend in one plane only. Alternatively, in certain embodiments, the actuator allow the flexible conduit to bend in more than one plane.

Endoscope 810 further includes an auxiliary conduit 830 (e.g., a detachable conduit) that includes a channel through which fiber 720 is threaded. The channel connects to a second channel in flexible conduit 815, allowing fiber 720 to be threaded through the auxiliary conduit into flexible conduit 815. Fiber 720 is attached to auxiliary conduit by a connector 831 in a matter than maintains the orientation of the fiber with respect the channel through flexible conduit 815, thereby minimizing twisting of the photonic crystal fiber about its waveguide axis within the flexible conduit. In embodiments where photonic crystal fiber 720 has a confinement region that includes a seam, the fiber can be attached to the auxiliary conduit so that the seam is not coincident with a bend plane of the flexible conduit.

In general, photonic crystal fibers can be used in conjunction with commercially-available endoscopes, such as endoscopes available from PENTAX Medical Company (Montvale, N.J.) and Olympus Surgical & Industrial America, Inc. (Orangeburg, N.Y.).

Laser system 800 includes a secondary cooling apparatus 840 in addition, or alternatively, to cooling apparatus 770. Photonic crystal fiber length 720 is placed within a sheath 844, which is connected to secondary cooling apparatus 840 by a delivery tube 842. Secondary cooling apparatus 840 cools photonic crystal fiber length 720 by pumping a cooling fluid through sheath 844.

Secondary cooling apparatus 840 can recirculate the cooling fluid it pumps through sheath 844. For example, sheath 844 can include an additional conduit that returns the cooling fluid to secondary cooling apparatus 840. A heat exchanger provided with the secondary cooling system can actively cool the exhausted cooling fluid before the secondary cooling system pumps the fluid back to sheath 844.

The cooling fluid can be the same or different as the cooling fluid pumped into the core of the photonic crystal fiber by cooling apparatus 770. In some embodiments, cooling apparatus 770 pumps a gas through the core of the fiber, while secondary cooling apparatus 840 cools the fiber using a liquid (e.g., water).

Sheath 844 can perform a protective function, shielding photonic crystal fiber length 720 from environmental hazards. In some embodiments, sheath 844 includes a relatively rigid material (e.g., so that sheath 844 is more rigid than photonic crystal fiber length 720), reducing flexing of photonic crystal fiber length 720. In some embodiments, sheath 844 is formed from a relatively rigid material, such as nitinol (commercially-available from Memry, Inc., Bethel, Conn.).

Examples of medical laser systems are shown in U.S. patent application Ser. No. 11/101,915, entitled “PHOTONIC CRYSTAL FIBERS AND MEDICAL SYSTEMS INCLUDING PHOTONIC CRYSTAL FIBERS,” and filed on Apr. 8, 2005, the entire contents of which are incorporated herein by reference.

While medical laser systems have been described, other applications for laser systems are also possible. For example, laser systems can be used in industrial applications, such as for cutting or etching materials, such as metals. Further applications include communications systems, such as in telecommunications networks.

Furthermore, while systems are described where a fiber waveguide is used to deliver two different wavelengths to a target, waveguides can be used to guide two or more different wavelengths for other purposes. For example, in embodiments where a length of photonic crystal fiber is used in a fiber amplifier or fiber laser, energy at a pump wavelength can be converted to energy at a wavelength guided by the core by a gain medium within the fiber (e.g., within the core of the fiber.

A number of embodiments of the invention have been described. Nevertheless, it will be understood that various modifications may be made without departing from the spirit and scope of the invention. Accordingly, other embodiments are within the scope of the following claims.

What is claimed is:

1. A method, comprising:
guiding radiation at a first wavelength, λ₁, through a core of a photonic crystal fiber; and
guiding radiation at a second wavelength, λ₂, through the photonic crystal fiber, wherein |λ₁−λ₂|>100 mm.

2. The method of claim 1, wherein the radiation at the first wavelength is coupled into the core of the photonic crystal fiber at an end of the photonic crystal fiber.

3. The method of claim 1, wherein the radiation at the second wavelength is coupled into the photonic crystal fiber at an end of the photonic crystal fiber.

4. The method of claim 1, wherein the radiation at the second wavelength is coupled into the photonic crystal fiber at a side of the photonic crystal fiber.

5. The method of claim 1, wherein the photonic crystal fiber includes a confinement region surrounding the core and a cladding surrounding the confinement region, and the radiation at the second wavelength is guided through the cladding.

6. The method of claim 1, wherein the first wavelength is in a range from about 1,300 nm to about 12,000 nm.

7. The method of claim 6, wherein the first wavelength is about 10,600 nm.

8. The method of claim 1, wherein the second wavelength is in a range from about 400 nm to about 700 nm.

9. A method, comprising:
guiding radiation at a first wavelength, λ₁, through a hollow core of a fiber waveguide; and
guiding radiation at a second wavelength, λ₂, through a portion of the fiber waveguide surrounding the core.

10. The method of claim 9, wherein the first and second wavelengths are different.

11. The method of claim 10, wherein |λ₁−λ₂|>100 nm.

12. The method of claim 10, wherein λ₁ is in the infrared region of the electromagnetic spectrum.

13. The method of claim 12, wherein λ₁ is about 10,600 nm.

14. The method of claim 10, wherein λ₂ is in the visible portion of the electromagnetic spectrum.

15. The method of claim 9, wherein the fiber waveguide comprises a cladding surrounding the core and the radiation at the second wavelength is guided through the cladding.

16. The method of claim 15, wherein the radiation at the second wavelength is guided by total internal reflection of the radiation at an interface between the cladding and another portion of the fiber waveguide or between the cladding and a gas or fluid.

17. The method of claim 16, wherein the interface is between the cladding and air.

18. The method of claim 9, wherein the fiber waveguide is a photonic crystal fiber.

19. A system, comprising:
a first radiation source configured to emit radiation at a first wavelength during operation of the first radiation source;
a second radiation source configured to emit radiation at a second wavelength during operation of the second radiation source; and
a photonic crystal fiber having an output end, the photonic crystal fiber being positioned to receive radiation at the first and second wavelengths from the first and second radiation sources during operation of the first and second radiation sources, respectively, and to guide the radiation at the first and second wavelengths to the output end.

20. The system of claim 19, wherein the first radiation source is a laser.

21. The system of claim 20, wherein the laser is a CO₂ laser.

22. The system of claim 20, wherein the second radiation source is a laser.

23. The system of claim 19, wherein the first and second wavelengths are different.

24. The system of claim 19, wherein the first wavelength is in a non-visible portion of the electromagnetic spectrum.

25. The system of claim 23, wherein the first wavelength is in the infrared portion of the electromagnetic spectrum.

26. The system of claim 23, wherein the second wavelength is in the visible portion of the electromagnetic spectrum.

27. The system of claim 19, further comprising a handpiece attached to the photonic crystal fiber, wherein the handpiece allows an operator to control the orientation of the output end to direct the radiation to a target location of a patient.

28. The system of claim 27, wherein the handpiece comprises an endoscope.

29. The system of claim 28, wherein the endoscope comprises a flexible conduit and a portion of the photonic crystal fiber is threaded through a channel in the flexible conduit.

30. The system of claim 29, wherein the endoscope comprises an actuator mechanically coupled to the flexible conduit configured to bend a portion of the flexible conduit thereby allowing the operator to vary the orientation of the output end.

31. The system of claim 27, wherein the handpiece comprises a conduit and a portion of the photonic crystal fiber is threaded through the conduit.

32. The system of claim 31, wherein the conduit comprises a bent portion.

33. The system of claim 27, wherein the photonic crystal fiber is sufficiently flexible to guide the radiation at the first and second wavelengths to the target location while a portion of the photonic crystal fiber is bent through an angle of about 90 degrees or more and the portion has a radius of curvature of about 12 centimeters or less.

34. The system of claim 19, wherein the radiation at the first wavelength has an average power at the output end of about 5 Watts or more.

35. The system of claim 19, wherein the photonic crystal fiber comprises a core and a confinement region surrounding the core, the core and confinement region both extending along a waveguide axis.

36. The system of claim 35, wherein the dielectric confinement region comprises a layer of a first dielectric material arranged in a spiral around the waveguide axis.

37. The system of claim 36, wherein the dielectric confinement region further comprises a layer of a second dielectric material arranged in a spiral around the waveguide axis, the second dielectric material having a different refractive index from the first dielectric material.

38. The system of claim 37, wherein the first dielectric material is a glass.

39. The system of claim 38, wherein the glass is a chalcogenide glass.

40. The system of claim 38, wherein the second dielectric material is a polymer.

41. The system of claim 36, wherein the dielectric confinement region comprises at least one layer of a chalcogenide glass.

42. The system of claim 36, wherein the dielectric confinement region comprises at least one layer of a polymeric material.

43. The system of claim 36, wherein the dielectric confinement region comprises at least one layer of a first dielectric material extending along the waveguide axis and at least one layer of a second dielectric material extending along the waveguide axis, wherein the first and second dielectric materials can be co-drawn with the first dielectric material.

44. The system of claim 36, wherein the core is a hollow core.

45. The system of claim 19, wherein the photonic crystal fiber is a Bragg fiber.

46. The system of claim 19, wherein the photonic crystal fiber is a holey fiber.

47. The photonic crystal fiber of claim 19, wherein the photonic crystal fiber comprises a confinement region surrounding a core of the photonic crystal fiber, and the confinement region comprises a spiral portion.

48. The photonic crystal fiber of claim 47, wherein the confinement region comprises a non-spiral portion.

49. The photonic crystal fiber of claim 48, wherein the non-spiral portion is located between the spiral portion and the core.

50. The photonic crystal fiber of claim 48, wherein the non-spiral portion is an annular portion.

51. A photonic crystal fiber configured to guide radiation at a wavelength λ, the photonic crystal fiber comprising:
a core extending along a waveguide axis;
a confinement region surrounding the core, the confinement region also extending along the waveguide axis;
a cladding surrounding the confinement region and extending along the waveguide axis, the cladding comprising a cladding material having a refractive index n_{C} at wavelength λ; and
a portion adjacent the cladding different from the confinement region, the portion also extending along the waveguide axis,
wherein the portion has a refractive index nₚ at wavelength λ, where nₚ<n_{c}.

52. The photonic crystal fiber of claim 51, wherein the cladding material is a polymer.

53. The photonic crystal fiber of claim 52, wherein the polymer comprises a polyolefin.

54. The photonic crystal fiber of claim 51, wherein the cladding material has a relatively low absorption at λ.

55. The photonic crystal fiber of claim 51, wherein the portion adjacent the cladding surrounds the cladding.

56. The photonic crystal fiber of claim 51, wherein the portion surrounding the cladding comprises one or more support structures positioned to maintain a separation between the cladding and an outer cladding surrounding the cladding.

57. The photonic crystal fiber of claim 51, wherein the portion comprises holey portions.

58. The photonic crystal fiber of claim 51, wherein the cladding comprises a material with a relatively low absorption at λ.

59. The photonic crystal fiber of claim 58, wherein the material is a polymer.
